(19) United States
(12) Patent Application Publication
(10) Pub. No.: US 2023/0184019 A1
(43) Pub. Date: Jun. 15, 2023

(54) GEARBOX AND DRIVING DEVICE THEREOF

(71) Applicant: JOHNSON ELECTRIC INTERNATIONAL AG, Murten (CH)

(72) Inventors: Jingning TA, HONG KONG (CN); Baofeng JI, Shenzhen (CN); Qiumei LI, HONG KONG (CN); Yongjun ZHAO, HONG KONG (CN)

(21) Appl. No.: 18/083,223

(22) Filed: Dec. 16, 2022

Related U.S. Application Data
(63) Continuation of application No. PCT/CN2021/090709, filed on Apr. 28, 2021.

(30) Foreign Application Priority Data
Jun. 19, 2020 (CN) 202010565132.4

(51) Int. Cl. E05F 15/611; F16H 1/32; F16H 57/023; F16H 57/08

(52) U.S. Cl. CPC E05F 15/611; F16H 1/32; F16H 57/023; F16H 57/082; E05Y 2900/546; E05Y 2201/72; E05Y 2201/604; E05Y 2201/628; E05Y 2201/682; E05Y 2201/706; E05Y 2201/726; F16H 2001/324; F16H 2001/327; F16H 57/028

(57) ABSTRACT

The present disclosure relates a gearbox for power lift gate including a rotating frame (22/22′) arranged in the housing and rotatable relative to the housing, a sun roller (23) and a plurality of planetary gears (24) supported by the rotating frame (22/22′), an inner ring tooth (218) provided in the housing, and the planetary gear (24) being surrounded around the sun roller (23) in the central area. The sun roller (23) includes a first rod (230) with helical teeth which is meshed with a first gear (240) of the planetary gear, and a second rod (232) extending coaxially from the first rod (230). The planetary gear includes a second gear (242) meshed with the inner ring gear (218) of the housing to drive the rotating frame to rotate and revolve synchronously for driving external loads.

### CROSS-REFERENCE TO RELATED APPLICATION

This application as a PCT international patent application, and claims priority to China Patent Application No. 202010565132.4, filed Jun. 19, 2020, the disclosure of which is hereby incorporated by reference herein in its entirety.

### FIELD

The present disclosure relates to the arts of gearbox, and more particularly to a driving device with gearbox used in power lift gate.

### BACKGROUND

Generally, as the most common power source, electric motors are widely used in all walks of life. The high-speed rotation of the motor is usually decelerated to a reasonable range via gearbox to drive load to rotate. Such as a motor with the gearbox is used as an actuator for electric tailgate of automobile, which includes a motor and a gearbox connected with the output shaft of the motor. The gearbox is preferably a planetary gearbox with a relatively large bearing capacity. Most of the planetary gearboxes has at least two-stage or three-stage planetary gear structures, and the rotation of the motor is greatly reduced after being decelerated step by step through the planetary gear mechanisms at all levels to increase the output torque of the motor.

However, the multi-stage planetary gearbox itself is more complex in structure, requires high precision in assembly, and is prone to noise, vibration, and acoustic harshness, which is not only costly, but also a poor experience, which is not expected by users.

### SUMMARY OF THE INVENTION

In view of this, the present disclosure provides a new type of gearbox and a driving device using the same, which is capable of effectively bearing a relatively heavy load and preventing reverse rotation.

The present disclosure discloses a gearbox and an actuator with the gearbox. The gearbox includes a housing, a rotating frame provided in the housing and rotatable relative to the housing, a sun roller and a plurality of planetary gears supported by the rotating frame, and an inner ting teeth formed in the housing. The sun roller has a first rod with helical teeth and a second rod supported by the rotating frame. Each planetary gear includes a first gear and a second gear coaxially and synchronously rotating with the first gear, the first gear is meshed with the helical teeth of the first rod, and the second gear is meshed with the inner ting teeth of the housing. A pin is arranged in the planetary gear and connected with the rotating frame for driving the rotating frame to rotate, and an output unit is located on the side of the rotating frame away from the planetary gears for driving external loads.

Furthermore, the present disclosure provides a driving device, which includes a motor and the above-mentioned gear box, and an rotating shaft of the motor is drivingly connected to the sun roller of the gear box.

The gear box of the driving device of the present disclosure transmits power of an external driving mechanism such as a motor to the planetary gear via the sun roller, and the planetary gear meshes with the housing with inner ring teeth to drive the rotating frame to rotate in reverse, thereby driving the output unit to rotate. Its overall structure is more compact, its coaxial performance is good, the rotation is more stable and the noise is low. Moreover, even if the output unit is subjected to a strong reverse load, it will not drive the rotating frame to rotate in the reverse direction to achieve the self-locking function of the gearbox.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiment.

FIG. 1 is a cross-sectional view of a driving device in accordance with an exemplary embodiment of the present disclosure.

FIG. 2 is an isometric view of a motor in accordance with a first embodiment of the present disclosure.

FIG. 3 is a cross-sectional view of a gearbox in FIG. 1.

FIG. 4 is an isometric exploded view of the gearbox in FIG. 2.

FIG. 5 is an isometric view of the gearbox in FIG. 2, viewed from another aspect.

FIG. 6 is an isometric view of another embodiment of a driving device according to the present disclosure.

FIG. 7 is a cross-sectional view of a gearbox in FIG. 6.

FIG. 8 is an isometric exploded view of the gearbox in FIG. 6.

### DETAILED DESCRIPTION OF THE PREFERRED EMBODIMENTS

Embodiments of the present disclosure will be described in detail in conjunction with the drawings. It should be noted that the figures are illustrative rather than limiting. The figures are not drawn to scale, do not illustrate every aspect of the described embodiments, and do not limit the scope of the present disclosure.

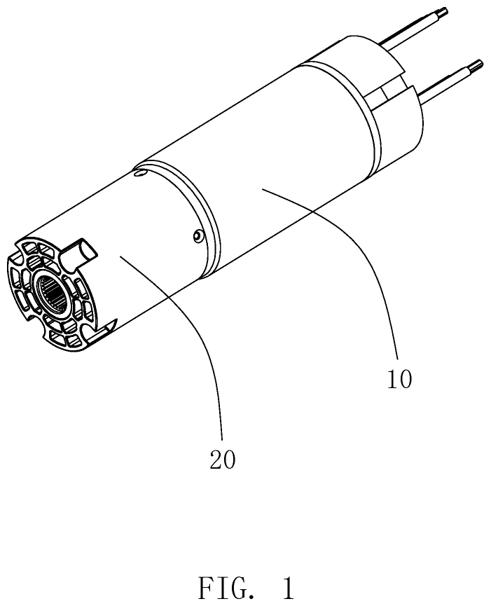

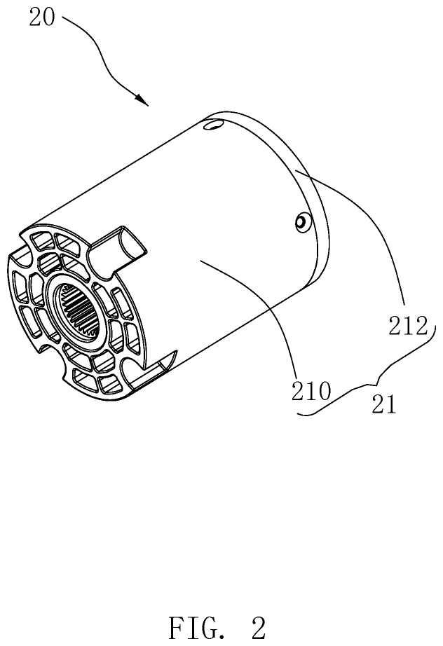

Referring to FIGS. 1-3, the present disclosure is applied to a power lift gate such as electric tailgate of an automobile. Generally, it has a motor 10 and a gearbox 20 driven by the motor 10. The gear box transmits the rotating torque of the motor to components such as a hydraulic rod for supporting the door panel. Under the condition of the gravity of the door panel, the gearbox will not rotate or slip in the opposite direction even under heavy load and has a self-locking function.

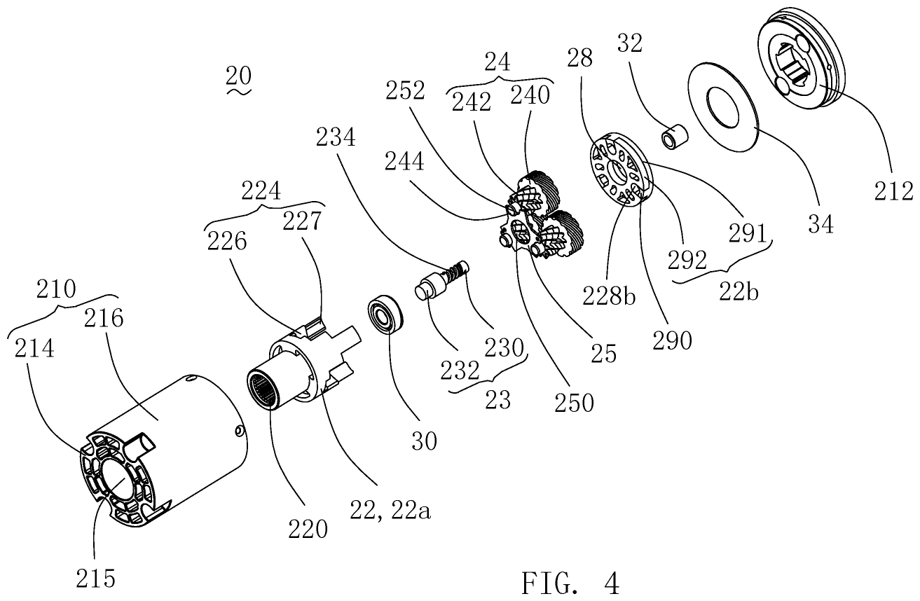

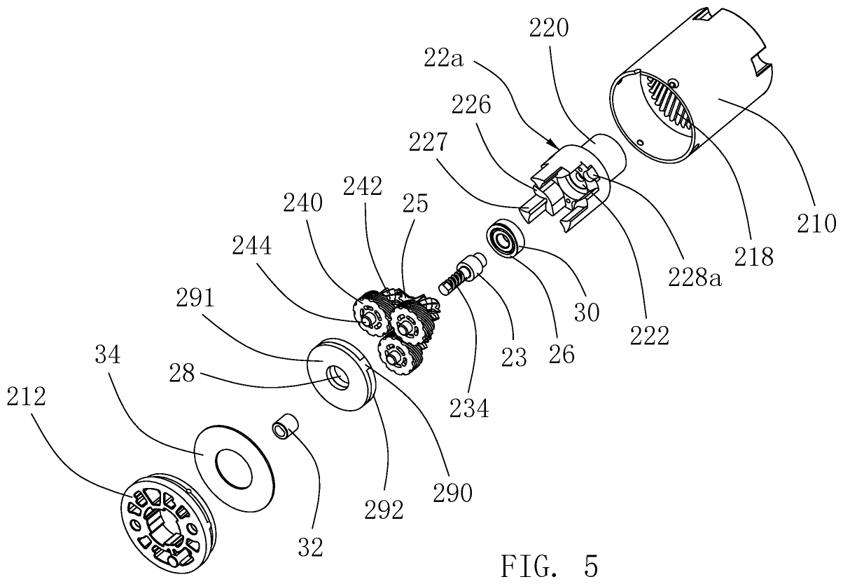

The motor 10 may be a brushless motor, a brushed motor or any power mechanism that can provide rotational torque, and it has an output shaft 12 extending outward. The output shaft 12 is inserted into the gearbox 20 to drive the gearbox to work. The gear box 20 serves as a reduction mechanism of the entire device, preferably a planetary gearbox. Referring to FIGS. 4 to 5 together, the gearbox 20 includes a housing 21, a rotating frame 22 received in the housing 21, and a sun roller 23 and a plurality of planetary gears 24 supported by the rotating frame 22. The planetary gear 24 surrounds the sun roller 23 and meshes with the sun roller each other. The housing 21 has an outer surface and a circular inner surface opposite to the outer surface, and an inner ring tooth 218 is formed on the inner surface of the housing 21. Each planetary gear 24 is sandwiched between the sun roller 23 and the inner ring teeth 218, so that the planetary gears 24 mesh with the sun roller 23 and the housing 21 synchronously. In this embodiment, there are at least three planetary gears 24. The amount of the planetary gears 24 is variable according to actual requirement.

In the present disclosure, the sun roller 23 is located at the center of the gearbox 20, and it is drivingly connected to the output shaft 12 of the motor 10. Specially, the sun roller 23 is rod-shaped as an integrated unit and includes a first rod 230 and a second rod 232 extending coaxially from the first rod 230. One end of the sun roller 23 is floatingly connected to the output shaft 12 via a connecting sleeve 32 and rotates synchronously, and the other end of the sun roller 23 is restrained in a bearing 30 in the rotating frame 22. The term floating connection here means that the sun roller 23 is displaced along an axial direction under the influence of load or its own motion. In a certain state, the end of the first rod 230 and the output shaft 12 may directly touch, in other states there will be a small gap between the end of the first rod 230 and the output shaft 12, so that the sun roller 23 can self-adjust its position, neither of which affects the operation of the sun roller 23. A helical tooth 234 are formed on at least a part of an outer surface of the first rod 230 for meshing with the planetary gear 24. In general, the output shaft 12 transmits torque to the sun roller 23 via the connecting sleeve 32, and the sun roller 23 drives the planetary gears 24 to rotate.

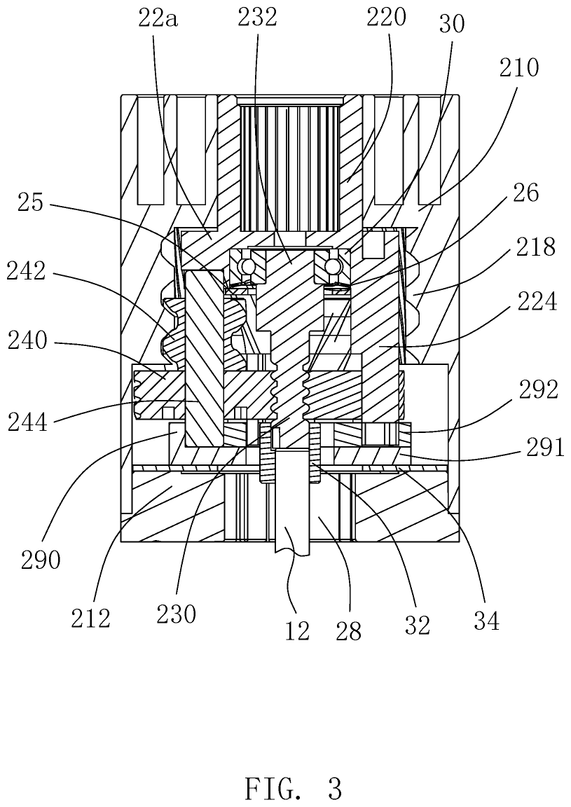

The rotating frame 22 serves as the power output element of the entire gearbox 20 and includes a rotating output 220 located at the side end of the gearbox 20 away from the motor 10 and used for connection with an external load. The rotating output 220 comprises a spline structure arranged axially inwardly and connected to the external load to output torque outwardly. The rotating frame 22 and the sun roller 23 have a coaxial line. The center of the rotating frame 22 facing the sun roller is concavely formed with a bearing seat 222. A bearing 30 is limited in the bearing seat 222. It may be a ball-bearing, ceramic bearings, or oil-impregnated bearings, etc. An end of the second rod 232 of the sun roller 23 is inserted into the bearing 30 as shown in FIG. 3. The rotating output 220 outputs torque to the external load in a speed much lower than the rotation speed of the output shaft 12 under the joint action of the sun roller 23, the planetary gears 24 and the housing 21.

An end of the first rod 230, as shown in FIG. 3, is connected to the end of the output shaft 12 by connecting sleeve 32. The connecting sleeve 32 may be a cylindrical structure formed by sintering or injection molding, and the end of the output shaft 12 and the end of the first rod 230 are respectively inserted into the connecting sleeve 32. In this embodiment, the end of the first rod 230 has a non-circular structure, and its cross section is in the shape of a letter “D”. Correspondingly, the end cross-section of the output shaft 12 and the cross-section of a central hole of the connecting sleeve 32 are both D-shaped. When the motor 10 is started, its output shaft 12 drives the sun roller 23 to rotate synchronously by the sleeve 32. The cross section of the central hole of the connecting sleeve 32 is not limited to the letter D shape, and may also be triangular, gear-shaped, and the like. When said motor 10 is started, its output shaft 12 drives the sun roller 23 by the sleeve 32 to rotate synchronously.

The plurality of planetary gears 24 are sandwiched between the sun roller 23 and the rotating frame 22 and are arranged at intervals with the sun roller 23 as a center. Each planetary gear 24 includes a first gear 240 and a second gear 242 coaxially extended from the first gear 240. In the embodiment, A diameter of the second gear 242 is smaller than that of the first gear 240. The first gear 240 meshes with the helical tooth 234 on the first rod 230 of the sun roller 23. The second gear 242 faces the rotating frame 22 and meshes with the inner ring tooth 218 of the housing 21. Preferably, the first gear 240 and the second gear 242 are integrated, and the sun roller 23 drives the first gear 240 and the second gear 242 to rotate synchronously.

The housing 21 includes a gear housing 210 and an end cover 212 cooperatively with the gear housing 210. The gear housing 210 is a cylindrical structure with an open 215, and includes an end plate 214 and a side plate 216 extending from the edge of the end plate 214 toward the end cover 212. The open 215 is formed in the center of the end plate 214, and the rotating output 220 of the rotating frame 22 penetrates outward through the open 215. The side plate 216 is arranged around the planetary gears 24, and the inner wall surface of the side plate 216 is in the shape of a step with a small top and a large bottom. A part of the side plate 216 surrounds the first gear 240 of the planetary gear 24, and the inner ring tooth 218 is formed on the inner wall surface of the other part of the side plate 216, and the inner ring tooth 218 meshes with the second gear 242 of the planetary gear 24. The second rod 232 of the sun roller 23 is positioned between the second gear 242.

In this embodiment, the rotating frame 22 includes a first rotating frame 22a and a second rotating frame 22b. A space is formed by the first rotating frame 22a together with the second rotating frame 22b for receiving the planetary gear 24 and the sun roller 23. The bearing seat 222 is recessed in the central area of the side of the first rotating frame 22a facing the second rotating frame 22b, and the rotating output 220 extends from the center of the side facing away from the second rotating frame 22b from the open 215.

The first rotating frame 22a further includes a plurality of supporters 224 extending perpendicularly from the edge toward the second rotating frame 22b. The radial portion of the planetary gear 24 protrudes from a gap between two adjacent supporters 224. In this embodiment, each supporter 224 includes a first convex arm 226 and a second convex arm 227 extending from the first convex arm 226. The second convex arm 227 is smaller than the first convex arm 226. A relatively narrow first space is formed between adjacent first convex arms 226 for accommodating the second gear 242. A wider second space is formed between adjacent second convex arms 227 for accommodating the first gear 240. The cross-sections of the first rotating frame 22a, the first convex arm 226 and the second convex arm 227 are stepped, and limit the first gear 240 and the second gear 242 in the axial direction.

In this embodiment, the central area of each planetary gear 24 is provided with a pin 244 along the axial direction. Two ends of the pin 244 respectively extend out of the first gear 240 and the second gear 242, and are respectively inserted into the two rotating frames 22a and 22b. A plurality of first inserted holes 228a are formed on the first rotating frame 22a for connecting one end of the pin 244. Each of the first inserted holes 228a is located at an intermediate position between two adjacent supporters 224. Correspondingly, a plurality of second inserted holes 228b are formed on the second rotating frame 22b, which are used to be inserted into the other end of the pin 244. Each of the second inserted holes 228b is aligned with a first inserted hole 228a.

A limiting plate 25 is provided between the planetary gear 24 and the rotating support 22a, and the limiting plate 25 is preferably in the shape of a sheet metal. The limiting plate 25 is generally triangular in shaped. A circular hole 250 is formed in the center to sleeve the second rod 232 of the sun roller 23. The outer edge of the limiting plate 25 forms a notch 252 corresponding to each pin 244. The notch 252 corresponds to the position and shape of the first inserted hole 228a of the first rotating frame 22a. In the embodiment, the limiting plate 25 is stacked on the first rotating frame 22a, and preferably they are formed with corresponding fixing holes, which can be connected by fixing parts such as screws and pins. The edge of the limiting plate 25 is provided with a recess to make way for each supporter 224. In addition, the limiting plate 25 may firmly abuts the bearing 30 in the first rotating frame 22a, prevent the bearing 30 from being pulled off by the sun roller 23, and effectively prevent the shaft 244 from shifting. Preferably, a wave-shaped elastic sheet 26 is arranged between the support 25 and the rotating support 22a. In this embodiment, the wave-shaped elastic sheet 26 is sandwiched between the limiting plate 25 and the first rotating frame 22a. Of course, in the present disclosure, the limiting plate 25 and the wave-shaped elastic sheet 26 can alternatively be installed on one side of the planetary gear 24, without affecting the operation of the gear box.

In this embodiment, the first inserted hole 228a is not a complete and regular hole. It penetrates the outer edge of the first rotating frame 22a and is a semi-open slot hole. The end of the pin 244 is inserted into the first inserted hole 228a. Referring to FIG. 4, the second rotating frame 22b includes an upper cover 291 and a lower cover 292 matching the upper cover 291. Both the upper cover 291 and the lower cover 292 are provided with an open in the central area. The edge area of the upper cover 291 is provided with a plurality of stoppers 290 protruding and extending in the direction of the lower cover plate 292, and the corresponding edge area of the lower cover plate 292 is provided with grooves, which are semi-open slot hole for receiving the end of the pin 244. Each stopper 290 of the upper cover 291 is inserted into corresponding groove of the lower cover plate 292 to form a second inserted hole 228b. Preferably, the groove is U-shaped, and the radial inner surface of the stopper 290 is a cylindrical surface. The stopper 290 and the groove together form a second inserted hole 228b that matches the pin 244. The end of the pin 244 fits into the second inserted hole 228b to ensure the stable rotation of the planetary gear 24. While assembled, the pin 244 is first inserted into the groove of the lower cover 292, and then the upper cover 291 is assembled so that the stopper 290 closes the groove to limit the pin 244.

Preferably, a gasket 34 is provided between the second rotating frame 22 and the end cover 212. The gasket 34 is made of wear-resistant material. In this embodiment, an outer diameter of the connecting sleeve 32 is smaller than the hole diameter of the through hole 28, and the sleeve 32 is freely received in the through hole 28. The end of the first rod 230 of the sun roller 23 floats through the second rotating frame 22b and the end cover 212. The end of the second rod 230 is constrained in the bearing 30 in the first rotating frame 22a. The position of the sun roller 23 may be adjusted by itself to ensure the coaxiality of the entire gearbox 20.

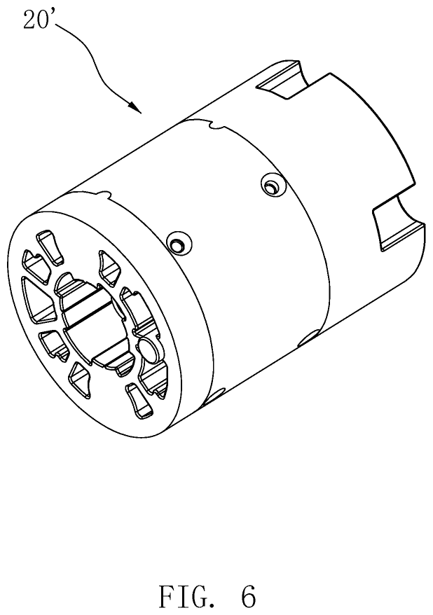

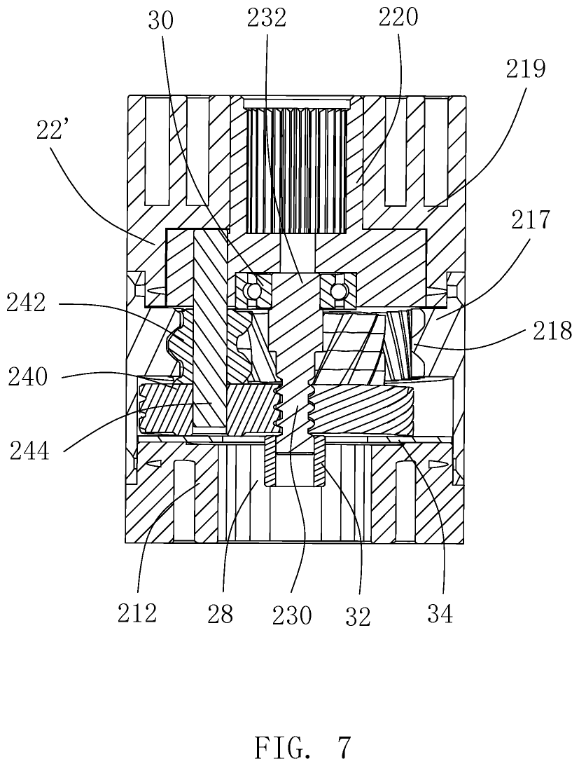

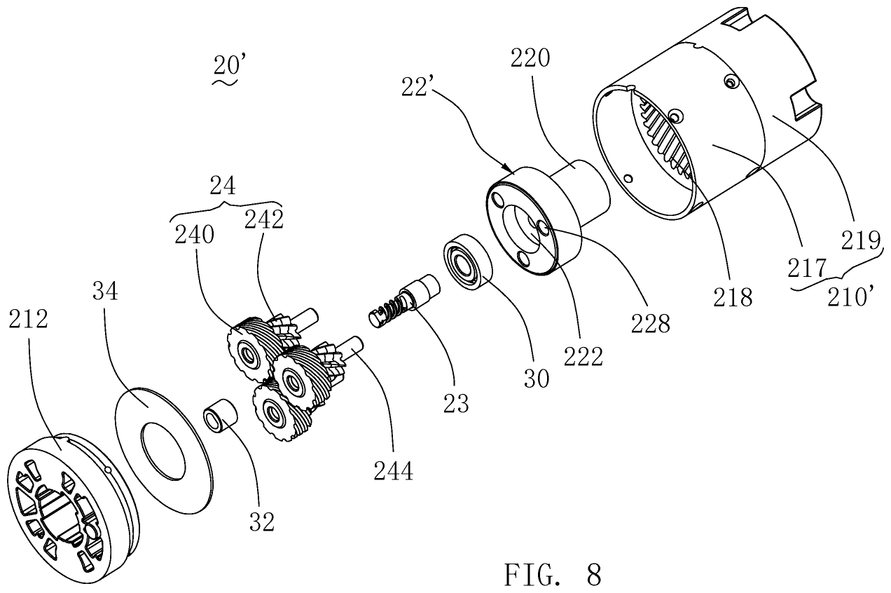

FIGS. 6-8 show another embodiment of the gearbox 20′ of the present disclosure. The difference from the first embodiment lies in the gear housing 210′ and the rotating frame 22′.

In this embodiment, the gear housing 210′ includes a first housing 217 and a second housing 219. Of course it can also be an integral structure. The first housing 217 is a cylindrical structure with two open provided on the both ends. The second housing 219 is a cylindrical structure with an open end, forming a larger space to achieve a stronger turret strength. The first housing 217 is located between the end cover 212 and the second housing 219. The inner ring gear 218 is formed on the inner wall surface of the first housing 217 to mesh with the second gear 242 of the planetary gear 24. The center of the side end of the second housing 219 is formed with the through hole 215 for passing through the rotating output 220 of the rotating frame 22′. The rotating frame 22′ is a single, and is received in the second housing 219. Similarly, the side of the rotating frame 22′ facing away from the end cover 212 forms the rotating output 220, and the side facing the end cover 212 forms a bearing seat 222, and is equipped with a bearing 30 to support the sun roller 23.

In addition, the rotating frame 22′ includes a circular hole 228 for each pin 244, omitting the supporter of the rotating frame 22′. The rotating frame 22′ includes a rotating output and a disc integrally extending from the rotating output. One end of the pin 244 is embedded in the first gear 240 and the other end is installed in the inserted hole 228 of the disc of the the rotating frame 22′. Preferably, the inserted hole 228 penetrates the rotating frame 22′. The other end of the shaft 244 is embedded in the inserted hole 228 to increase the pivoting length of the rotating frame 22′ and the pin 244 to ensure the rigidity and stability of the connection. The wear-resistant gasket 34 is disposed between the planetary gears 24 and the end cover 212. The connecting sleeve 32 is movably arranged in a through hole 28 of the gasket 34 and the end cap 212. The sun roller 23 is drivingly connected to the output shaft 12 of the motor 10 via the sleeve 32. The sun roller 23 is in a floating state and may be adjusted in a small range to ensure the coaxiality of the entire gearbox 20′.

The high-speed rotation of the motor 10 of the driving device of the present disclosure is transmitted to the planetary gear 24 via the sun roller 23 of the gear box 20/20′. The planetary gear 24 rotates and revolves synchronously under the common constraint of the sun roller and the gear housing with inner ring teeth to drive the rotating frame to rotate and output. The sun roller 23 is different from the traditional sun roller in that it can carry a large load and can also prevent the reverse transmission of power. The motor 10 may drive a load through the gearboxes 20, 20′, but it is difficult to drive the gearboxes 20′ back by the load to achieve self-locking. Due to the action of the inner ring gear 218 of the gear housing 210 and the second gear 242, the planetary gear 24 revolves around the sun roller 23 while rotating, driving the rotating frame 22/22′ connected to it and its rotating output 220 to the sun roller 23 rotates as the center to output torque outward. The rotation speed of the motor is decelerated by the planetary gear 24, and the rotation speed of the rotating output 220′ is greatly reduced relative to the sun roller 23, so that the output torque is increased.

The first gear 240 and the second gear 242 of the planetary gear 24 respectively mesh with the sun roller 23 and the inner ring teeth 218 of the housing for transmission, so that the gearbox 20/20′ are integrally constituted as one-stage planetary gears with good coaxiality. The overall size of the gearbox 20/20′, including the axial size and the radial size, can be effectively reduced. However, the rotating frame 22/22′, etc. can have a large size, and the strength of the connection with the planetary gear 24 is sufficient, and the two have enough force to ensure the smooth rotation of the planetary gear 24, reduce noise generation, and improve the overall performance, especially in NVH.

While the present disclosure has been described with reference to a specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

1. A gearbox for power lift gate including: a housing, a rotating frame (22/22′) arranged in the housing and rotatable relative to the housing, a sun roller (23) and a plurality of planetary gears (24) supported by the rotating frame (22/22′), an inner ring tooth (218) provided in the housing, and the planetary gears (24) being surrounded around the sun roller (23) in the central area, characterized in that:
the sun roller (23) includes a first rod (230) with helical teeth and a second rod (232) extending coaxially from the first rod (230);
each planetary gear includes a first gear (240) and a second gear (242) which are extending coaxially from the first gear (240) and rotate synchronously, the first gear (240) meshes with the helical teeth of the first rod (230) of the sun roller (23), and the second gears (242) mesh with the inner ring tooth (218) of the housing;
each planetary gear (24) is installed in the rotating frame (22/22′) via a pin for driving the rotating frame to rotate, and rotating output (220) is provided on the side of the rotating frame far away from the planetary gears (24) for connecting to external loads.

2. The gearbox for power lift gate as defined in claim 1, wherein the rotating frame (22) further includes a plurality of supporters (224) extending perpendicularly from the edge toward the planetary gears (24), a gap formed between two adjacent supporters (224), and a radial portion of each planetary gear (24) protrudes from the gap to mesh with the inner ring teeth (218) of the housing.

3. The gearbox for power lift gate as defined in claim 2, wherein each supporter (224) includes a first convex arm (226) and a second convex arm (227) extending from the first convex arm (226) along an axial direction.

4. The gearbox for power lift gate as defined in claim 3, wherein the second gear (242) of each planetary gear (24) is received between adjacent first convex arm (226) to form a space, and the first gear (240) of each planetary gear (24) is received between adjacent second convex arm (227) to form a space.

5. The gearbox for power lift gate as defined in claim 1, wherein a plurality of inserted holes are formed in the rotating frame (22/22′), and at least one end of the pin (244) in each planetary gear (24) is fixed into a corresponding inserted hole.

6. The gearbox for power lift gate as defined in claim 1, wherein the rotating frame further includes a first rotating frame (22a) and a second rotating frame (22b), a space formed by the first rotating frame (22a) together with the second rotating frame (22b) for receiving the planetary gear (24) and the sun roller (23), and a plurality of inserted holes are formed in the rotating frame (22/22) for fixing the pin (244).

7. The gearbox for power lift gate as defined in claim 6, wherein the first inserted hole (228a) penetrates the outer edge of the first rotating frame (22a) to form a semi-open slot hole to receive the pin (244).

8. The gearbox for power lift gate as defined in claim 6, wherein the second rotating frame (22b) includes an upper cover (291) and a lower cover (292) matching the upper cover (291).

9. The gearbox for power lift gate as defined in claim 8, wherein a groove is formed on the edge of the lower cover (292), a stopper (290) is formed on the upper cover (291) for matching the groove, and the stopper is inserted into the radially outer edge of the groove to form an inserted hole of the second rotating frame (22b) for fixing the pin (244).

10. The gearbox for power lift gate as defined in claim 1, wherein a limiting plate (25) is sandwiched between the planetary gears (24) and the rotating support, a hole (250) is formed in the center to receive the second rod (232) of the sun roller (23), and a notch (252) is formed on the outer edge of the limiting plate (25) for receiving the pin (244).

11. The gearbox for power lift gate as defined in claim 1, wherein the center of the rotating frame facing the planetary gear (24) is recessed to form a bearing seat (222), a bearing (30) is positioned in the bearing seat (222) for arranging an end of the second rod (232) of the sun roller (23).

12. The gearbox for power lift gate as defined in claim 1, wherein an end cover (212) supports the planetary gears (24), a connecting sleeve (32) is movably arranged in a through hole (28) of the end cap (212) for connecting an output shaft of motor with the first rod (230) of the sun roller (23).

13. The gearbox for power lift gate as defined in claim 1, wherein a gasket (34) is provided between the planetary gears (24) and the end cover (212).

14. A driving device for power lift gate including the gearbox of claim 1 and an output shaft of a motor transmits torque to the sun roller (23) of the gearbox, the gearbox comprising:
a housing, a rotating frame (22/22′) arranged in the housing and rotatable relative to the housing, a sun roller (23) and a plurality of planetary gears (24) supported by the rotating frame (22/22′), an inner ring tooth (218) provided in the housing, and the planetary gears (24) being surrounded around the sun roller (23) in the central area, characterized in that:
the sun roller (23) includes a first rod (230) with helical teeth and a second rod (232) extending coaxially from the first rod (230);
each planetary gear includes a first gear (240) and a second gear (242) which are extending coaxially from the first gear (240) and rotate synchronously, the first gear (240) meshes with the helical teeth of the first rod (230) of the sun roller (23), and the second gears (242) mesh with the inner ring tooth (218) of the housing;
each planetary gear (24) is installed in the rotating frame (22/22′) via a pin for driving the rotating frame to rotate, and rotating output (220) is provided on the side of the rotating frame far away from the planetary gears (24) for connecting to external loads.

15. The driving device for power lift gate as defined in claim 14, wherein the rotating frame further includes a first rotating frame (22a) and a second rotating frame (22b), a space formed by the first rotating frame (22a) together with the second rotating frame (22b) for receiving the planetary gear (24) and the sun roller (23), and a plurality of inserted holes are formed in the rotating frame (22/22′) for fixing the pin (244).

16. The driving device for power lift gate as defined in claim 15, wherein the second rotating frame (22b) includes an upper cover (291) and a lower cover (292) matching the upper cover (291).
